(19) United States
(12) Patent Application Publication
(10) Pub. No.: US 2010/0070398 A1
(43) Pub. Date: Mar. 18, 2010

(54) SYSTEM AND METHOD FOR COMBINED ANALYSIS OF PAID AND INCURRED LOSSES

(75) Inventors: Bouke Hessel POSTHUMA, Den Haag (NL); Eric Alexander CATOR, Delft (NL); Wilhelmus Johannes Josephus VEERKAMP, Rijswijk (NL); Erik Willem VAN ZWET, Leiden (NL)

Correspondence Address: YOUNG & THOMPSON, 209 Madison Street, Suite 500, Alexandria, VA, 22314, US

(73) Assignee: POSTHUMA PARTNERS IFM BV, 'S-GRAVENHAGE (NL)

(21) Appl. No.: 12/536,742

(22) Filed: Aug. 6, 2009

Related U.S. Application Data
(60) Provisional application No. 61/087,400, filed on Aug. 8, 2008.

(51) Int. Cl. G06Q 40/00

(52) U.S. Cl. 705/35

(57) ABSTRACT

A method for combined analysis of paid and incurred losses, includes defining a first data array of a plurality of payments as paid losses, defining a second data array of a plurality of reserves as incurred losses, each of the plurality of the payments and the plurality of reserves having a multivariate normal distribution and joining the first data array and the second data array as a joint dataset, under a condition of equality of payments and reserves for a predetermined loss period.

Motivation. The new solvency regimes now emerging, insist that capital requirements align with the underlying (insurance) risks. This paper explains how a stochastic model built on basic assumptions is used to monitor insurance risk in order to get a clear insight in the aligned economic capital including prudence margins for loss reserves.

Method. The incurred loss of an insurer consists of payments on claims and reserves for claims that have been reported. As all claims are settled eventually, the cumulative paid and incurred losses for a given loss period become equal. Therefore, a joint model for the paid and incurred loss arrays is constructed, following a multivariate normal distribution, conditioned on equality of the total paid and incurred losses for a given loss period. A new class of functions is designed specifically to model development curves.

Results. A simulation experiment proved that a joint model for both paid and incurred loss arrays as described under Method, leads to a more accurate prediction of loss reserves. While the standard way of estimating percentiles for the reserve is biased, the alternative method of bootstrapping will lead to more accurate outcomes.

Conclusions. Modeling paid and incurred losses jointly leads to a considerable improvement in loss reserving in terms of accuracy of predictions, as well as specification of percentiles.

### 1. INTRODUCTION

The new risk based solvency regimes now emerging, such as the Solvency II rules to be implemented in Europe in 2009, insist that capital requirements align with the underlying (insurance) risks. This makes a stochastic loss reserving model a necessity. Such a model needs straightforward assumptions that will allow that:
risk for expired insurance contracts is integrated together with risk for future contracts, in order to get a complete insight into the risk of the insurance portfolio as a whole, and that
incomplete data—such as imperfect loss triangles due to varying period lengths or even incidental missing values—is still constructive to the model.

Regression as a descriptive technique with basic probability assumptions often offers the possibility to efficiently create an appropriate stochastic framework.

In short, an insurer will have to examine previous payments to make predictions about all future financial obligations. However, the company needs to know more than just how much money it should expect to pay. The model's stochastic ranges generate economic capital and prudence margins for reserves. Therefore, an adequate assessment of percentile ranges is crucial.

Typically, an insurer will arrange his payments by loss period and development period in a rectangular loss array, which is also sometimes called a run-off table. Since some of the payments lie in the future, this array is not fully observed. The observed part is often referred to as a run-off triangle. We regard the unobserved part of the loss array as a collection of random variables and the goal is to determine their probability distributions as well as possible on the basis of the available data.

Naturally, an extensive literature exists on this important problem. Perhaps the most widely used approach is the Chain Ladder. Renshaw and Venal (1998) identify the underlying assumptions and Mack (1993) and England and Venal (1999) present ways of estimating the standard error of the prediction. There are countless alternatives to the Chain Ladder and Schmidt (2007) has compiled a 35-page bibliography on the subject of loss reserving!

Much of the existing literature, however, concerns only a single array of payments—an exception is the Munich Chain Ladder introduced by Quarg and Mack (2004). Indeed, in most cases we have two arrays: an array of payments on settled claims and an array of reserves for claims that have been reported, but not yet settled. We refer to the sum of payments and reserves as “incurred loss”.

In this paper, we aim to analyze the paid and incurred loss arrays jointly. As all claims are settled eventually, the reserves vanish and the cumulative paid and incurred loss for a given loss period become equal. On the basis of this observation, we construct a joint model. In our description, each array follows a multivariate normal distribution, conditioned on equality of the total paid and incurred losses for a given loss period.

This paper is organized as follows. In the next section we present an overview of our multivariate normal model for the two arrays. We then proceed to give a more detailed description, defining a particular family of functions that is very useful for modeling development curves. In most cases, we observe only various aggregates of the arrays, but we show that this poses no difficulties. We discuss prediction and parameter estimation. To examine the advantage of our joint model we conducted a simulation experiment. We compared the results of the joint model to those obtained from using only a single array. We find that the joint model shows better results in terms of the mean squared prediction error. We report on these results in the final section.

### 2. MULTIVARIATE NORMAL MODEL

Let Yₗₖ⁽¹⁾ and Yₗₖ⁽²⁾ denote the incremental paid and incurred losses for loss period 1=1, 2, . . . , L in development period k=1, 2 . . . , K. Suppose that they are all independent normally distributed with means

EYₗₖ⁽¹⁾=μₗΠₖ⁽¹⁾ and EYₗₖ⁽²⁾=μₗΠₖ⁽²⁾

and variances

var(Yₗₖ⁽¹⁾)=\tilde{Π}ₖ⁽¹⁾ and var (Yₗₖ⁽²⁾)=\tilde{Π}ₖ⁽²⁾.

We assume

$${\sum }_{k} {Π}_{k}^{( 1 )} = {\sum }_{k} {Π}_{k}^{( 2 )} = 1.$$

It is of course sensible to assume a parametric form for the parameter vectors μ, Π⁽¹⁾, Π⁽²⁾, \tilde{Π}⁽¹⁾ and \tilde{Π}⁽²⁾. For ease of presentation, we defer this issue to the next section.

The assumed normal distribution of the entries of the loss arrays is often not appropriate. Occasional large claims result in distributions that are skewed to the right. To account for this skewness the entries are sometimes assumed to have the lognormal distribution. A disadvantage of such a model is the incompatibility of the log normal distribution with the negative values that do occur in practice in most arrays, and the incompatibility of the distribution when aggregating data (the sum of two lognormal random variables is not log normally distributed). Also, it will not be feasible to do what we are about to propose—that is, condition on the equality of the row sums of the loss arrays.

We should point out that as a result of the Central Limit Theorem, aggregates of the data are more normally distributed than the individual entries. We feel that the advantages of the multivariate normal model outweigh those of the multivariate lognormal model.

Let Y⁽¹⁾1 and Y⁽²⁾1 denote the row sums of the matrices Y⁽¹⁾ and Y⁽²⁾. Also, we can stretch out Y⁽¹⁾ and Y⁽²⁾ as length KL vectors y⁽¹⁾ and y⁽²⁾, respectively.

Given the event {Y⁽¹⁾1=Y⁽²⁾1}, the vectors y⁽¹⁾ and y⁽²⁾ have multivariate normal distributions. It is not difficult to determine the conditional mean and conditional covariance matrix. Refer to the Appendix for a general formulation.

Because EY⁽¹⁾1=EY⁽²⁾1, the conditional mean of the vectors y⁽¹⁾ and y⁽²⁾ is the same as the unconditional mean. However they are of course no longer independent!

Let Σ₁₁ denote the unconditional covariance matrix of the length 2KL vector y=y⁽¹⁾,−y⁽²⁾).

$${Σ}_{11} = ( \begin{matrix}Cov ( {y}^{( 1 )} ) & 0 \\ 0 & Cov ( {y}^{( 2 )} )\end{matrix} ) , \qquad ( 2.1 )$$

where Cov(y⁽¹⁾) and Cov(y⁽²⁾) are the diagonal covariance matrices of y⁽¹⁾ and y⁽²⁾. We use −y⁽²⁾ for convenience, since in that case the row sums add up to zero.

Let Σ₂₂ denote the covariance matrix of (Y⁽¹⁾−Y⁽²⁾)1. Then

$${Σ}_{22} = ( {\sum }_{k} {\tilde{Π}}_{k}^{( 1 )} = {\sum }_{k} {\tilde{Π}}_{k}^{( 2 )} ) I ,$$

where I is the L×L identity matrix.

Let Σ₁₂=Σ′₂₁ denote the covariance between y and (Y⁽¹⁾−Y⁽²⁾)1.

The conditional covariance matrix of y given the event {Y⁽¹⁾−Y⁽²⁾)1=0} is

Σ=Σ₁₁−Σ₁₂Σ₂₂⁻¹Σ₂₁ (2.2)

This completes the global specification of our model. In the next section we give a more detailed description.

### 3. DETAILED SPECIFICATION OF THE MODEL

In the previous section, we introduced vectors με [symbol] and Π⁽¹⁾, Π⁽²⁾ε [symbol] , to describe the expectations. Define

$$Π = ( \begin{matrix}{Π}^{( 1 )} \\ - {Π}^{( 2 )}\end{matrix} ) .$$

Mostly, we have a vector of “exposures” Wε [symbol] representing a volume measure for each loss period, such as the total number of insurance policies. We choose an L×p matrix X and a parameter vector βε [symbol] and we model the expected total loss for loss period l

μₗ=Wₗe^{(Xβ)}^{ₗ} (3.1)

We have

E(Yₗₖ⁽¹⁾)=Wₗe^{(Xβ)}^{ₗ}Πₖ⁽¹⁾ and E(Yₗₖ⁽²⁾)=Wₗe^{(Xβ)}^{ₗ}Πₖ⁽²⁾.

This means that if we define for matrices A and B of equal size

exp(A)ᵢⱼ=e^{A}^{ᵢⱼ} and (A∘B)ᵢⱼ=AᵢⱼBᵢⱼ,

then we can write

E(y)=(W∘exp(Xβ)) [symbol] Π

where [symbol] denotes the tensor product between two vectors.

Next, we recall the vectors \tilde{Π}⁽¹⁾, \tilde{Π}⁽²⁾ε [symbol] , which represent the (unconditional) variances. Define their sums as σ₁² and σ₂²;

$${\sum }_{k = 1}^{K} {\tilde{Π}}_{k}^{( 1 )} = {σ}_{1}^{2} and {\sum }_{k = 1}^{K} {\tilde{Π}}_{k}^{( 2 )} = {σ}_{2}^{2} .$$

Also define

$$\tilde{Π} = ( \begin{matrix}{\tilde{Π}}^{( i )} \\ {\tilde{Π}}^{( 2 )}\end{matrix} ) .$$

We model the unconditional variances for loss period l and development period k as

\tilde{V}ₗₖ⁽¹⁾:=Var(Yₗₖ⁽¹⁾)=Wₗe^{(Xβ)}^{ₗ}\tilde{Π}ₖ⁽¹⁾ and \tilde{V}ₗₖ⁽²⁾:=Var(Yₗₖ⁽²⁾)=Wₗe^{(Xβ)}^{ₗ}\tilde{Π}ₖ⁽²⁾.

Note that we use the same X and β as we did for the expectations. In matrix notation this becomes

Cov(y)=((W∘exp(Xβ)) [symbol] \tilde{Π})_{Δ}.

Here we denote the diagonal matrix with the vector v as its diagonal by v_{Δ}. This describes the unconditional distribution of the vector y. We can now use (2.2) to find the conditional distribution of y, which then completely specifies our model.

### 3.1 Modeling the Development Curves

For a sensible approach to the estimation problem, it is necessary to limit the number of parameters by assuming a parametric model for the development vectors Π⁽¹⁾, Π⁽²⁾, \tilde{Π}⁽¹⁾ and \tilde{Π}⁽²⁾. To explain our method, let us concentrate on one of the arrays, for example Y⁽¹⁾. We suppose that in loss period l, we expect a total loss of μₗ. Now suppose that the length of the loss period is T time units. The claims occurring in the small interval [t,t+Δt], have an effect on the expected loss in the time interval [s,s+Δs], t≦s equal to

$$\frac{{μ}_{l} Δ t}{T} {f}_{θ} ( s - t ) Δ s$$

where ƒ_{θ} is a (possibly negative) function such that

∫_{θ}^{∞}f_{θ}(x)dx=1,

for all possible choices of the parameter vector θ.

In the next section, we will describe a particular family of such functions, which possess some desirable properties. For now, let us note that the total loss over loss period l equals μₗ. Indeed, if [tₗ,tₗ+T] denotes the loss period l,

$$\frac{1}{T} {\int }_{{t}_{l}}^{{t}_{l} + T} {μ}_{l} {\int }_{t}^{∞} {f}_{θ} ( s - t ) d s d t = {μ}_{l} .$$

We are interested in the expected loss from loss period l in development period k. Denote with Iₖ the interval corresponding to this development period. We see that

$$\begin{matrix}{Π}_{k} = \frac{1}{T} {\int }_{{t}_{l}}^{{t}_{l} + T} {\int }_{{t}_{l} ⊕ {I}_{k} ⋂ [ t , ∞ ]} {f}_{θ} ( s - t ) d s d t \\ = \frac{1}{T} {\int }_{0}^{T} {\int }_{{I}_{k} ⋂ [ t , ∞ ]} {f}_{θ} ( s - t ) d s d t .\end{matrix}$$

Usually, the loss and development periods have the same length T. We can choose T=1 so that Iₖ=[k−1, k]. We get

Π₁=∫_{θ}¹∫ₜ¹ƒ_{θ}(s−t)dsdt (3.2)

Πₖ=∫_{θ}¹∫ₖ₋₁^{k}ƒ_{θ}(s−t)dsdt, k≧2 (3.3)

If we define the survival function

S_{θ}(x)=∫ₓ^{∞}ƒ_{θ}(y)dy

and the function

H_{θ}(x)=∫₀^{x}S_{θ}(y)dy

then we can rewrite (3.2) as

Π₁=∫₀¹(1−S_{θ}(1−t))dt=1−H_{θ}(1),

and (3.3) as

Πₖ=∫₀¹(S_{θ}(k−1−t)−S_{θ}(k−t))dt=2H_{θ}(k−1)−H_{θ}(k)−H_{θ}(k−2).

We conclude that it is useful to choose the functions θ_{θ} in such a way that we can calculate H_{θ} explicitly. In the next section we will do just that. We conclude this section by mentioning that the development of the variances is modeled in a similar way. In that case we do need to make sure that the functions θ_{θ} are always positive.

### 3.2. A Parametric Family of Functions

Now, we will introduce a parametric family of functions that meet the requirement of the previous section.

{ƒ(x;β,γ,μ,σ):β,γ,σ>0,μ≧0},

where xε[0,∞), These functions all satisfy

∫₀^{∞}ƒ(x;β,γ,μ,σ)dx=1(∀β,γ,σ>0,μ≧0).
ƒ(x;β,γ, μ,σ)=Cx^{γ-1}+o(x^{γ-1})(x↓0) for some C>0, depending on the parameters.
ƒ(x;β,γ,μ,σ)=Cx^{-2-β}+o(x^{-2-β})(x→∞) for some Cε [symbol] , depending on the parameters.

Furthermore, there exist analytic expressions for both the first and the second primitive of the function ƒ(.;β,γ,μ,σ). Finally, for μ>1, ƒ(.;β,γ,μ,σ) will have a negative tail.

We will use an auxiliary variable y to define our parametric family, and at first ignore the dependence on the scaling parameter σ. Define

$$y ( x ) = {\int }_{0}^{x} {( 1 + {( \frac{tB ( \frac{1}{γ} , \frac{β}{γ} )}{γ} )}^{γ} )}^{- \frac{1 + β}{γ}} d t$$

where

B(a,b)=∫₀¹t^{a-1}(1−t)^{b-1}dt

is the incomplete regularized beta-function. Now define

$$f ( x ; λ , β , γ , μ , 1 ) {=}^{def} ( 1 + β ) {{x}^{γ - 1} ( B ( \frac{1}{γ} , \frac{β}{γ} ) / γ )}^{γ} {( 1 + {( \frac{xB ( \frac{1}{γ} , \frac{β}{γ} )}{γ} )}^{γ} )}^{- 1 - \frac{1 + β}{γ}} \times ( 1 - μ {y ( x )}^{γ} ) + γ μ {y ( x )}^{γ - 1} {( 1 + {( \frac{xB ( \frac{1}{γ} , \frac{β}{γ} )}{γ} )}^{γ} )}^{- \frac{2 + 2 β}{γ}} .$$

Finally, we include the scale parameter σ so that

$$f ( x ; λ , β , γ , μ , σ ) {=}^{def} \frac{1}{σ} f ( \frac{x}{σ} ; λ , β , γ , μ , 1 ) . \qquad ( 3.4 )$$

We verify that

$$\begin{matrix}H ( x ; λ , β , γ , μ , 1 ) = {\int }_{0}^{x} {\int }_{t}^{∞} f ( s ; λ , β , γ , μ , 1 ) d s d t \\ = ( x ) - \frac{μ {y ( x )}^{1 + γ}}{1 + γ}\end{matrix}$$

and

$$H ( x ; λ , β , γ , μ , σ ) = σ H ( \frac{x}{σ} ; λ , β , γ , μ , 1 ) .$$

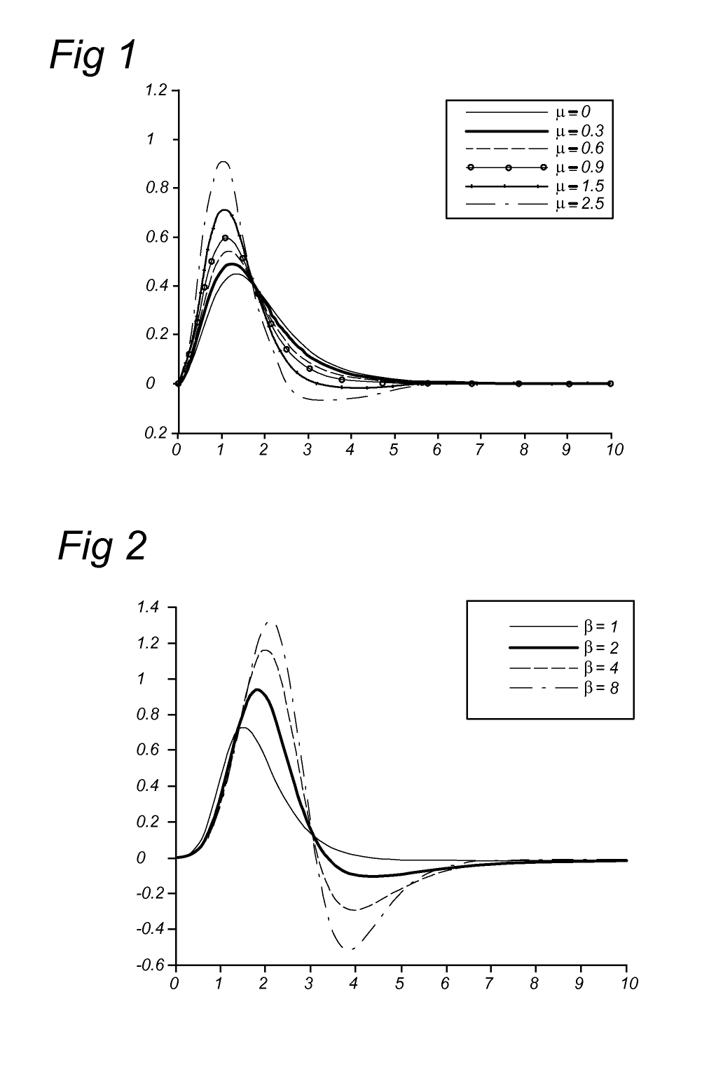

We will now describe the effect of the various parameters on the shape of the development function. The parameter μ is the most interesting parameter. If we choose μ≦1, we get a positive density, whose left and right tail behavior is determined by γ and β respectively. As μ approaches 1, the bump around the mode becomes more pronounced. When μ>1, the density “falls through” the x-axis, only to approach it again as x→∞; the tail behavior is still determined by γ and β. See FIG. 1, which shows the behavior of the density when varying μ. Note that from the previous section it follows that

$${\int }_{0}^{∞} xf ( x ; β , γ , μ , σ ) d x = ( 1 - \frac{μ}{1 + γ} ) σ$$

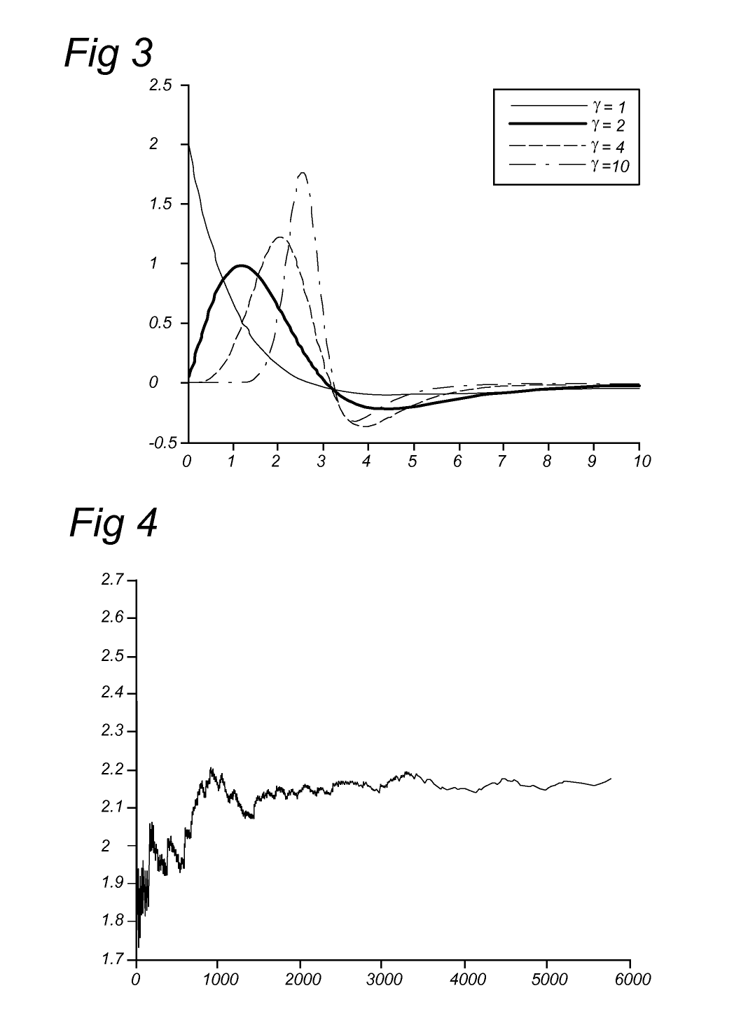

The effect of the parameters β and γ is similar to the behavior of these parameters in the parametric family of positive densities we get when we choose μ=0. The parameter β determines the right tail of the density, whereas γ determines the left-tail (near zero). FIG. 2 shows the behavior of the density when varying β. FIG. 3 shows the behavior of the density when varying γ. In FIGS. 2 and 3 we chose μ=5.

### 4. AGGREGATE OBSERVATIONS

Often we do not observe all the elements of the vector y individually, but compounded in various aggregates. For instance, for certain years we may only have records of payments per quarter, while for other years payments per month are available.

Suppose we observe J aggregates. If we assume that different aggregates never involve the same payments, we can introduce a zero-one matrix S with pair wise orthogonal rows, of size J×2KL. Observing various independent sums of the elements of the vector y then corresponds to z=Sy.

Conditionally on {(Y⁽¹⁾−Y⁽²⁾)1=0}, z has a multivariate normal distribution with mean SEy and covariance matrix, SΣS′ where Σ is given in (2.2). The advantage of choosing a multivariate normal model is very prominent here, since in this case it is still feasible to determine the likelihood of the data z.

### 5. ESTIMATION AND PREDICTION

We can estimate the parameters of our model by maximizing the likelihood of the data. If we call the vector of parameters θ, then we maximize

lik(θ)=P_{θ}(z=z|Y⁽²⁾−Y⁽²⁾)1=0) (5.1)

The parameter vector θ is very high dimensional. Indeed, there are at least 16 parameters describing the (unconditional) means and variances of the Yₗₖ⁽¹⁾ and Yₗₖ⁽²⁾. Maximizing (5.1) is a delicate affair and must involve some iterative procedure. The speed and success will depend on the algorithm which is used and, perhaps even more importantly, on the starting point. The starting point should be some ad hoc estimator, which is relatively easy to compute but still reasonably close to the true maximum likelihood estimator.

To evaluate the accuracy of our estimates we use standard theory for maximum likelihood estimation. That is, we use the Hessian of the log likelihood at the maximum likelihood estimate to approximate the Fisher information.

Typically, we are not so much interested in the parameters, as we are in a prediction of the reserve. Conditionally on the data and the equality of the row sums, the reserve has a multivariate normal distribution and we can use the conditional expectation as a prediction. The uncertainty in this prediction is a combination of the stochastic uncertainty of the model and the uncertainty in the parameter estimates.

### 6. SIMULATION

To evaluate the effect of conditioning on the equality of the row-sums, we conduct a simulation experiment. We estimate the reserve with conditioning on equal row-sums, using the run-off tables simultaneously, as described in this paper. We refer to this approach as the joint method. For comparison, we also estimated the reserve without conditioning on the row-sums, essentially only using the paid table. We call this approach the marginal method. Of course, the marginal method is much easier, as it involves no conditioning. However, result in this section show that the more complicated joint method does produce better results.

We carry out the following simulation experiment. We consider a set of actual insurance data that, for reasons of privacy, we have made anonymous by multiplying with some undisclosed factor. We fit a model using the parametric family of densities described in section 3 for the development curves of the expectation and variance of both the paid and the incurred table. This results in a 19 dimensional parameter θ₀, which contained
2×4=8 parameters for the two expectation development curves.
2×4=8 parameters for the two variance development curves.
3 parameters for the exposure (β) to account for 2 regime changes.

We define: R, the reserve as the sum of future payments and \hat{R}, the estimator for R.

For this data set we estimate the reserve \hat{R}₀ for the paid table and its variance \hat{V}₀ conditioned on the aggregated data and taking into account both the stochastic uncertainty and the parameter uncertainties. We find \hat{R}₀=5.24 and \hat{V}₀=2.04.

Next, we simulate two entire tables (paid and incurred) from the multivariate normal model determined by the estimated parameter vector θ₀, and repeat this about 6000 times. By using the estimated parameter vector, we make sure that our simulated data resembles realistic data. Of course, for each simulated data set, we know the “true” reserve R, as the sum of total simulated future payments. Hereafter, the estimated reserve \hat{R} is based on the simulated data set of historical payments. The error in the estimated reserve, as the difference between R and \hat{R}, is compared for the two methods.

### 6.1 Reserve Estimation

Denote R as the true reserve in a given simulated data set, \hat{R}₁, and \hat{R}₂ as the estimates for the reserve for the joint and marginal methods, respectively. One of the most important measures for the quality of a prediction is the Mean Squared Error (MSE). Our simulation showed that

E(R−\hat{R}₁)²=2.18

E(R−\hat{R}₂)²=6.90

Clearly, by using both tables simultaneously we achieve superior performance. We remark here, that using more simulations would not have changed this conclusion. FIG. 4 depicts a convergence of the average mean squared error for method 1 (the joint method). In FIG. 4 we show the convergence of the average of the squared error for the joint method as the number of simulations increases. We see that the average has sufficiently stabilized towards the end. The convergence for the marginal method is very similar.

The bias of the estimators is also important

E(\hat{R}₁−R)=−0.18

E(\hat{R}₂−R)=−0.32

We note that the bias of both methods is very small compared to the MSE. It is not surprising that we find a similar bias for both methods, since the expectation structure in both models is the same. Recalling that the MSE consists of the estimator's variance and its squared bias, we conclude that large MSE of the marginal method is an immediate consequence of its inability to correctly estimate this covariance structure.

It is also interesting to see how well both methods do at determining the accuracy of the estimate. We have calculated a conditional variance of the estimated reserve, given the data, taking into account the uncertainty in the parameter estimates. This leads to

median(\hat{V}₁)=1.63

median(\hat{V}₂)=4.28.

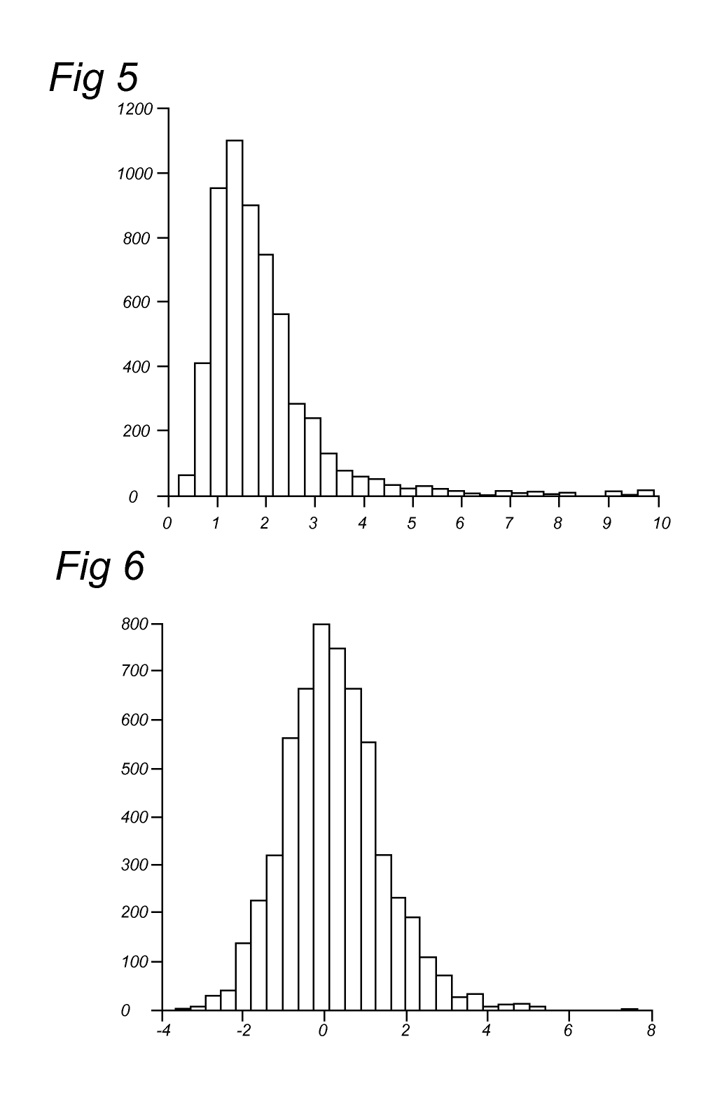

Since the reserve estimates are almost unbiased, these values should be close to the mean squared errors. This is not the case; both methods underestimate the variance. This is also clearly visible in FIG. 5 where we plot the histogram of the estimated variances. FIG. 5 shows a histogram of the estimated variance for the joint method. The skewness indicates that we frequently underestimate the variance. This is a problem, when we want to estimate percentiles. We address this issue in the next sub-section.

### 6.2 Estimating Percentiles

For loss reserving it is typically not sufficient to only have a point estimate of the reserve; percentiles are also needed. In this sub-section we discuss why the standard approach to estimating the percentiles does not work well in our case. We also provide an alternative.

The standard way of estimating percentiles is based on the following idea. When we estimate R by \hat{R}, and we estimate the variance by \hat{V}, we assume that the standardized residuals are approximately standard normal distributed. That, is

$$\frac{R - \hat{R}}{\sqrt{\hat{V}}} ∼ N ( 0 , 1 )$$

Then we can use the percentiles of the standard normal to find approximate percentiles for the reserve. We used this method to estimate the 75% and the 95% percentiles. To verify the results, we look at the percentage of times the true (simulated) reserve was larger than the estimated percentile. This gives
P(R>\hat{q}₇₅)=0.32 and P(R>\hat{q}₉₅)=0.12 for the joint method
P(R>\hat{q}₇₅)=0.36 and P(R>\hat{q}₉₅)=0.19 for the marginal method

Both methods seem to underestimate the percentiles, and we checked that this effect does not disappear as we increase the number of simulations. This is very troubling as it will lead to overoptimistic loss reserving.

FIG. 6 shows a histogram of the standardized residuals for the joint method. In FIG. 6 we plot the histogram of the standardized residuals for the joint method, and note that the distribution is not standard normal at all! Not only is it skewed, but also its mean is 0.24 instead of 0 and its variance is 1.49 instead of 1. This explains why the percentiles are not estimated accurately. The problem originates with the underestimation of the variance we discussed in the previous section, since having a small variance leads to a small percentile.

We conclude that the standard approach to estimating the percentiles does not work well. Therefore, we would like to suggest an alternative approach. The idea is simple: use the distribution of FIG. 6 instead of the standard normal to calculate percentiles. This is essentially an application of the bootstrap. This would lead to a 75-th percentile of 0.95, (instead of 0.67 for the standard normal) and a 95-th percentile of 2.37 (instead of the familiar 1.65). For our original data set with \hat{R}₀32 5.24 and \hat{V}₀=2.04 this means that the percentiles for the reserve are given by
\hat{q}₇₅=6.60 and \hat{q}₉₅=8.62 using the bootstrap method.
\hat{q}₇₅=6.20 and \hat{q}₉₅=7.59 using the normal method.

The relative difference between the two methods becomes more pronounced for higher percentiles, mainly because the relative contribution of the estimated reserve \hat{R}₀ diminishes.

Performing the many simulations needed to determine the distribution of the standardized residuals is a substantial computational burden. It took us four days to create FIG. 6. In certain applications this is prohibitive.

Although the distribution of FIG. 6 is specific to our particular data set, it is certainly conceivable that similar distributions would result from other data sets. Indeed, for data sets concerning similar insurance products this seems plausible at least. This suggests the following approach. We perform the simulations for a number of different data sets with varying characteristics. Then, when confronted with a new data set, we choose the histogram that is most appropriate, and use it instead of the standard normal to calculate percentiles.

Another suggestion to deal with this problem is judging the standardized residuals of the original loss triangle data set, given the parameter estimates. While the kurtosis of these residuals differs from the normality 3-value, the percentiles for loss reserves should be adjusted by taking these percentiles from a t-distribution, whereby the degree of freedom depends on the magnitude of the difference for the calculated kurtosis and the value 3.

### 7. CONCLUSION

The incurred loss of an insurer consists of payments on claims and reserves for claims that have been reported. As all claims are settled eventually, the cumulative paid and incurred losses for a given loss period become equal. On the basis of this observation, we construct a joint model for the paid and incurred loss arrays. In our description, each follows (or has) a multivariate normal distribution, which is conditioned on equality of the total paid and incurred losses for a given loss period. On the basis of this model, we make predictions for future payments.

A rather technical, but important feature of our model is the use of a new parametric family of functions that are ideally suited for modeling development curves.

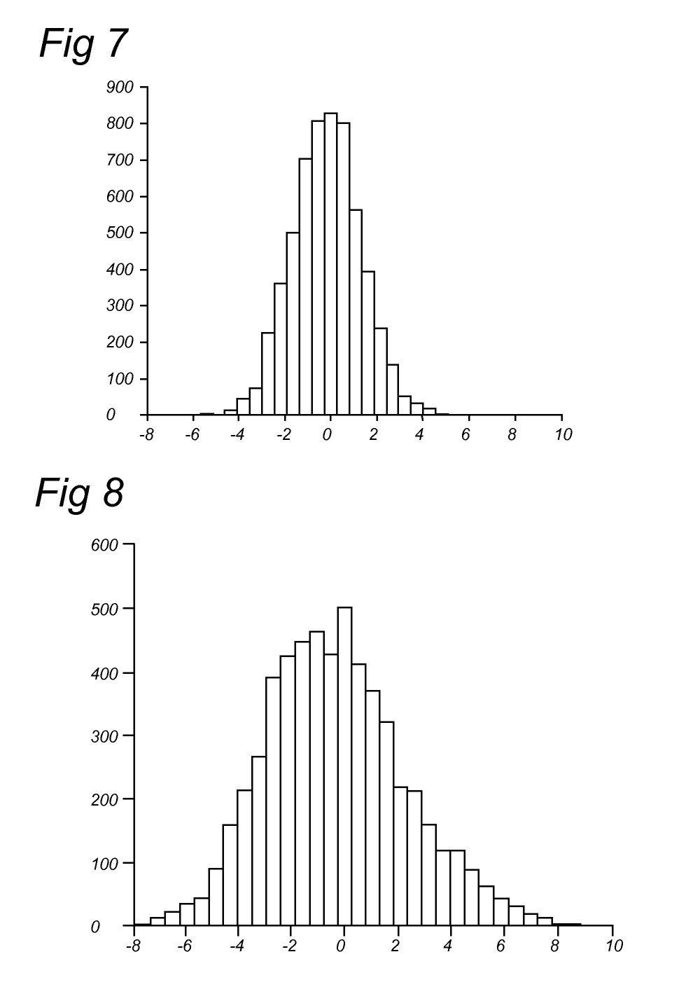

We have compared the performance of the joint model of the paid and incurred losses to an approach where we analyze only the paid table. FIGS. 7 and 8 show a histogram of the difference between the true and estimated reserve based on the joint model and the marginal model, respectively.

In FIGS. 7 and 8 we present the results of a simulation study. These figures show histograms of the difference of the true and predicted reserves for both methods. While both methods are approximately unbiased, the one based on the joint model has much smaller variance. A more detailed discussion of this result is found in the previous section, but here we conclude that joint modeling is to be preferred over utilizing only the paid table.

Since the practice of loss reserving also takes the distribution of the reserve into account, we have studied the estimation of percentiles as well. We noted that inference from the normal assumptions does not produce good results. In fact, the results would lead to over-optimistic assessment of economic capital and prudence margins, which is of course to be avoided. We have proposed an alternative approach based on the bootstrap. It entails performing many simulations, to replace the assumed standard normal distribution of the standardized residuals with a more accurate description. Carrying out this method requires substantial computational effort, which in practice is only feasible on a highly aggregated level.

### APPENDIX A

For ease of reference, we recall a well-known fact about the multivariate normal distribution.

Consider a random vector X, which is distributed according to the multivariate normal distribution with mean vector μ and covariance matrix Σ. Suppose we partition X into two sub-vectors

$$X = ( \begin{matrix}{X}^{( 1 )} \\ {X}^{( 2 )}\end{matrix} ) .$$

Correspondingly, we write

$$μ = ( \begin{matrix}{μ}^{( 1 )} \\ {μ}^{( 2 )}\end{matrix} ) and Σ = ( \begin{matrix}{Σ}_{11} {Σ}_{12} \\ {Σ}_{21} {Σ}_{22}\end{matrix} )$$

Now, if det(Σ₂₂)>0, then the conditional distribution of X⁽¹⁾ given X⁽²⁾ is multivariate normal with mean

μ⁽¹⁾−Σ₁₂Σ₂₂⁻¹(X⁽²⁾−μ⁽²⁾)

and covariance matrix

Σ₁₁−Σ₁₂Σ₂₂⁻¹Σ₂₁

### APPENDIX B

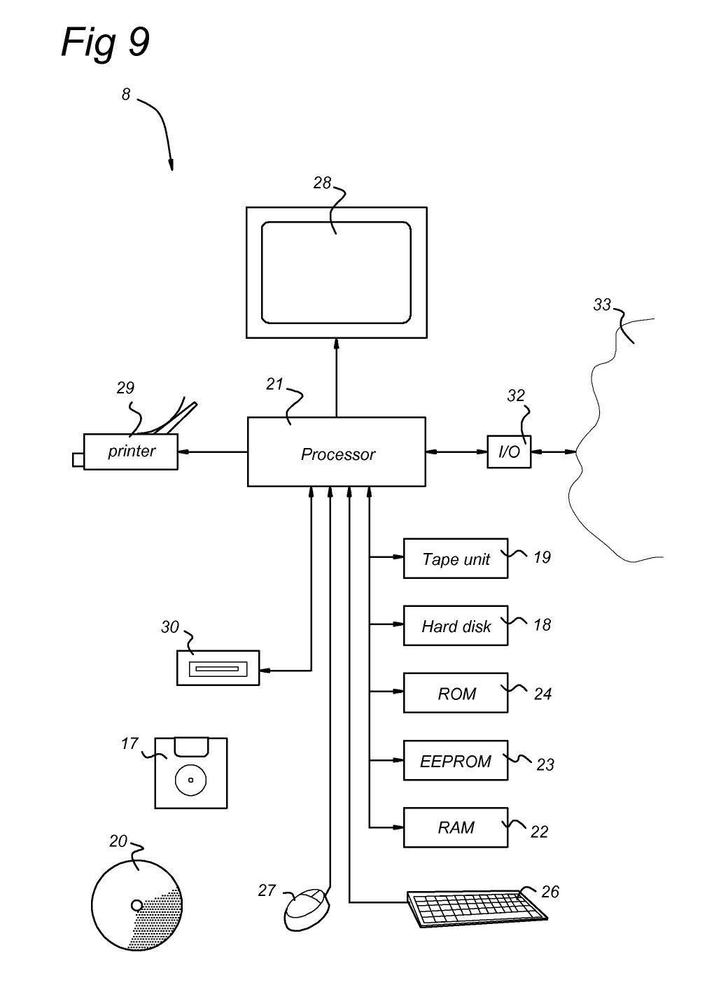

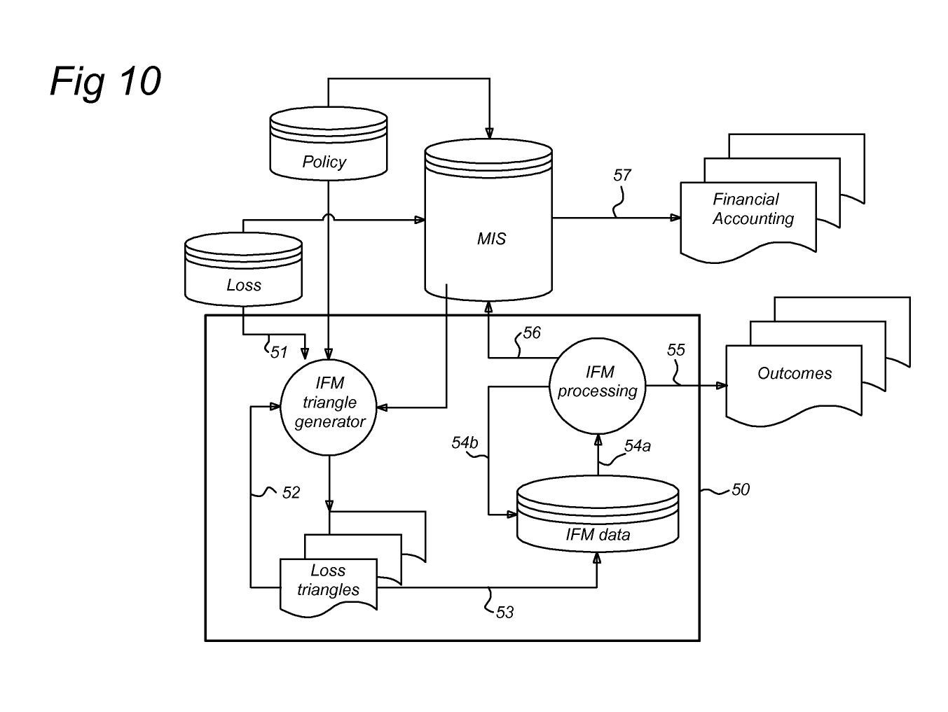

FIG. 9 shows schematically a computer arrangement which implements an embodiment of the present invention. Computer system 8 comprises host processor 21 with peripherals. The host processor 21 is connected to memory units 18, 19, 22, 23, 24 which store instructions and data, one or more reading units 30 (to read, e.g., floppy disks 17, CD ROM's 20, DVD's, memory cards), a keyboard 26 and a mouse 27 as input devices, and as output devices, a monitor 28 and a printer 29. Other input devices, like a trackball, a touch screen or a scanner, as well as other output devices may be provided.

Further, a network I/O device 32 is provided for a connection to a network 33.

The memory units shown comprise RAM 22, (E)EPROM 23, ROM 24, tape unit 19, and hard disk 18. However, it should be understood that there may be provided more and/or other memory units known to persons skilled in the art. Moreover, one or more of them may be physically located remote from the processor 21, if required.

The processor 21 is shown as one box, however, it may comprise several processing units functioning in parallel or controlled by one main processor, that may be located remotely from one another, as is known to persons skilled in the art.

The host processor 21 comprises functionality either in hardware or software components to carry out their respective functions as described in more detail below. Skilled persons will appreciate that the functionality of the present invention may also be accomplished by a combination of hardware and software components. As known by persons skilled in the art, hardware components, either analogue or digital, may be present within the host processor 21 or may be present as separate circuits which are interfaced with the host processor 21. Further it will be appreciated by persons skilled in the art that software components may be present in a memory region of the host processor 21.

The computer system 8 shown in FIG. 9 is arranged for performing computations in accordance with the method of the present invention. The computer system 8 is capable of executing a computer program (or program code) residing on a computer-readable medium which after being loaded in the computer system allows the computer system to carry out the method of the present invention.

The method as described above is capable calculations relating to predictions of ultimate loss ratios as claim frequency, loss ratio and risk premium and other insurance statistics useful to management. It generates loss provisioning including agreed prudence margin and economic capital in accordance with IFRS (and GAAP) regulations

The method can be elaborated in software aimed as part of insurers' MIS as schematically shown in FIG. 10.

The method as described above is depicted within the rectangular square 50 in the scheme of FIG. 10. The scheme also shows the required data trajectories. In this scheme, IFM relates to Integral Financial Modelling.

At the end of each reporting period, policy and loss data (payments and case reserves) from the insurers' systems (MIS) must be loaded into the method (see line 51).

As will be appreciated by the skilled in the art, the formation of the various triangles depends on the characteristics of the insurer, the lines of business and the required structure of management reports (see line 56).

The loss triangles generated by the IFM triangle generator are input to the IFM data which are processed further (IFM processing) in accordance with the method presented above. The results are output to the MIS at line 56 and may be output separately at line 55.

It is noted that the optimization procedure for maximum likelihood estimation takes minus the logarithm of the likelihood function as its criterion function. Its gradient and Hessian are evaluated using numerical differentiation. Search directions are based on the Newton-Raphson procedure, although other numerical procedures may be usable as well. Whenever the Hessian matrix is not sufficiently positive definite, this matrix is adjusted along its diagonal to satisfy positive definitiveness. A search direction is scanned using a line search procedure. Whenever the Hessian matrix is positive definite it is reused for some iterations.

As soon as such a calculation is performed it is stored in the database, whether it is saved or not. Upon redoing an optimization, data, settings and model specification will be recognized and earlier optimization results will be displayed without further optimization.

The number of iterations, as displayed under maximum likelihood results, can be interpreted as the number of numerical evaluations of the Hessian matrix.

The method to be carried out by the computer system comprises:

defining a first data array of a plurality of payments as paid losses;
defining a second data array of a plurality of reserves as incurred losses, each of the plurality of the payments and the plurality of reserves having a multivariate normal distribution;
joining the first data array and the second data array as a joint dataset, under a condition of equality of payments and reserves for a predetermined loss period.

According to an aspect, the method comprises:

determining an expected total loss for the predetermined loss period.

According to an aspect, the method comprises:

creating a development function from a conditional distribution function under the condition of equality of payments and reserves for the predetermined loss period.

According to an aspect, the method comprises:

parameterizing the development function into a parameterized development function.

According to an aspect, the method comprises:

estimating parameters of the parameterized development function by maximizing a likelihood of data in the joint dataset of the plurality of payments and the plurality of reserves.

According to an aspect, maximizing the likelihood of the data in the joint dataset is based on determination of a Hessian of the log likelihood.

According to an aspect, the method comprises:

estimating the reserves based on the estimated parameters.

According to an aspect, the method comprises:

estimating a variance of the plurality of the payments and a variance of the plurality of the reserves.

According to an aspect, the method comprises:

estimation of percentiles of the plurality of payments and percentiles of the based on a computation of a distribution of standard residuals of the joint dataset.

According to an aspect, the method comprises:

predicting future payments based on the estimated percentiles.

The invention may take the form of a computer program containing one or more sequences of machine-readable instructions describing a method as disclosed above, or a data storage medium (e.g. semiconductor memory, magnetic or optical disk) having such a computer program stored therein.

### 8. REFERENCES

[1] England, P. and Venal, R. J., “Analytic and bootstrap estimates of prediction errors in claims reserving”, 1999, Insurance: Mathematics and Economics 25, 281-291.
[2] Mack, T., “Distribution-free calculation of the standard error of chain ladder reserve estimates”, 1993, ASTIN Bulletin 23, 213-225.

[3] Quarg, G. and Mack, T., “Munich chain ladder: A reserving method that reduces the gap between IBNR projections based on paid losses and IBNR projections based on incurred losses, 2004, Blätter DGVFM, Heft 4, 597-630.

[4] Renshaw, A. E. and Venal, R. J., “A stochastic model underlying the chain ladder technique”, 1998, British Actuarials Journal 4, 903-923.

[5] Schmidt, K. D., “A bibliography on loss reserving”, 2007, www.math.tu-dresden.de/sto/schmidt/dsvm/reserve.pdf

1. Method for combined analysis of paid and incurred losses, comprising:
defining a first data array of a plurality of payments as paid losses;
defining a second data array of a plurality of reserves as incurred losses, each of the plurality of the payments and the plurality of reserves having a multivariate normal distribution;
joining the first data array and the second data array as a joint dataset, under a condition of equality of payments and reserves for a predetermined loss period.

2. Method according to claim 1, comprising:
determining an expected total loss for the predetermined loss period.

3. Method according to claim 2, comprising:
creating a development function from a conditional distribution function under the condition of equality of payments and reserves for the predetermined loss period.

4. Method according to claim 3, comprising:
parameterizing the development function into a parameterized development function.

5. Method according to claim 4, comprising:
estimating parameters of the parameterized development function by maximizing a likelihood of data in the joint dataset of the plurality of payments and the plurality of reserves.

6. Method according to claim 5, wherein maximizing the likelihood of the data in the joint dataset is based on determination of an Hessian of the log likelihood.

7. Method according to claim 5, comprising:
estimating the reserves based on the estimated parameters.

8. Method according to claim 5, comprising:
estimating a variance of the plurality of the payments and a variance of the plurality of the reserves.

9. Method according to claim 7, comprising estimation of percentiles of the plurality of payments and percentiles of the based on a computation of a distribution of standard residuals of the joint dataset.

10. Method according to claim 9, comprising predicting future payments based on the estimated percentiles.

11. System comprising a processing unit (21) and memory (18, 19, 22, 23, 24), the processing unit being connected to the memory, wherein the computer system (8) is arranged for carrying out:
defining a first array of a plurality of payments as paid losses;
defining a second array of a plurality of reserves as incurred losses, each of the plurality of the payments and the plurality of reserves having a multivariate normal distribution;
joining the first array and the second array as a joined dataset, under a condition of equality of payments and reserves for a predetermined loss period.

12. Computer program on computer-readable medium to be loaded by a system (8); the system comprising processing unit (21), memory (18, 19, 22, 23, 24), the processing unit (21) being connected to the memory (18, 19, 22, 23, 24), wherein the computer program product after being loaded allows the processing unit (21) to carry out:
defining a first array of a plurality of payments as paid losses;
defining a second array of a plurality of reserves as incurred losses, each of the plurality of the payments and the plurality of reserves having a multivariate normal distribution;
joining the first array and the second array as a joined dataset, under a condition of equality of payments and reserves for a predetermined loss period.

13. Computer-readable medium being provided with a computer program in accordance with claim 12.
